(19) United States
(12) Patent Application Publication
(10) Pub. No.: US 2012/0249001 A1
(43) Pub. Date: Oct. 4, 2012

(54) LIGHTING POWER SUPPLY DEVICE

(75) Inventors: Takashi OKUBO, Tokyo (JP); Yuji Yamanaka, Tokyo (JP)

(73) Assignee: MITSUMI ELECTRIC CO., LTD., Tokyo (JP)

(21) Appl. No.: 13/435,779

(22) Filed: Mar. 30, 2012

(30) Foreign Application Priority Data
Mar. 31, 2011 (JP) 2011-077397

(51) Int. Cl. H05B 37/02

(52) U.S. Cl. 315/200 R

(57) ABSTRACT

A lighting power supply device includes a control circuit controlling a transistor that controls a drive current flown through a lamp, receiving a pulsating flow converted from an alternating current by a rectifying circuit rectifying the alternating current subjected to phase control by a phase-controlled dimmer, and generating/outputting direct current voltage/current supplied to the lamp. The control circuit includes a time-voltage conversion circuit converting a time decided according to a phase of a voltage corresponding to the pulsating flow into a voltage; and a terminal to which a capacitor with an arbitrary capacitance value is connectable. The time-voltage conversion circuit allows the capacitor to generate a charging voltage corresponding to the phase of the pulsating flow. A sample-and-hold circuit takes in the charging voltage of the capacitor at predetermined timing corresponding to a change of an output of a voltage comparison circuit, and holds/outputs the taken-in voltage until next timing.

### BACKGROUND OF THE INVENTION

1. Field of the Invention

The present invention relates to a lighting power supply device that performs dimming by using a phase-controlled dimmer, and particularly to a light emitting diode (LED) lighting power supply device capable of controlling dimming of a lighting device that uses the LED.

2. Description of Related Art

In recent years, for the purpose of reducing an amount of carbon dioxide emission, a lighting fixture (hereinafter, referred to as an LED lamp) provided with an LED that consumes less electric power has been becoming widespread in place of an incandescent lamp that consumes much electric power. Heretofore, in a power supply device for the LED lamp, there has been proposed a technique for controlling dimming by using a phase-controlled dimmer (see Japanese Patent Application Laid-Open Publication No. 2007-227155 as a Patent Literature 1). Moreover, also in a power supply device for the incandescent lamp, such dimming control that uses the phase-controlled dimmer is performed.

As disclosed in the Patent Literature 1, the power supply device for the LED, which includes the phase-controlled dimmer, is composed of: a phase-controlled dimmer including a thyristor or a triac as a switching element receiving an alternating current power supply voltage from a commercial alternating current power supply, and including a control unit that controls to switch on/off the switching element; a rectifying circuit that converts an alternating current into a direct current; a lighting power supply circuit having an AC-DC converter that supplies desired electric power to the LED lamp; and the like. In the phase-controlled dimmer, an ON-phase angle of the switching element is controlled by the control unit in response to a resistance value of a variable resistor as dimming adjusting means, and the like, whereby a duty ratio of the alternating current power supply voltage is changed, and the dimming of the LED connected to the lighting power supply circuit is performed.

In such an LED lighting power supply device using the phase-controlled dimmer, it is necessary to control brightness of the LED lamp based on an input signal as shown in FIG. 8A. Therefore, desirably, in a control circuit of such an LED lighting power supply device, a time-voltage conversion circuit is provided, which generates a time-voltage conversion signal with a rectangular waveform as shown in FIG. 8B, the time-voltage conversion signal having a pulse width corresponding to a phase, from the input signal as shown in FIG. 8A, and converts the pulse width of the conversion signal concerned into a voltage, and then an LED drive current is controlled based on the voltage subjected to such time-voltage conversion.

As the time-voltage conversion circuit, for example, a circuit as shown in FIG. 9 is conceived. The circuit of FIG. 9 is composed of: a comparator CMP that generates, from the input signal of FIG. 8A, such a pulse signal as shown in FIG. 8B, the pulse signal corresponding to the phase; a CR filter FLT that is provided on a subsequent stage to the comparator CMP and generates a direct current voltage corresponding to the pulse width; and a voltage follower VF that performs impedance conversion for the generated voltage and transmits the voltage concerned.

However, though plural dimmers in which variable ranges (variable angles) of adjusting knobs (operation dials) differ from one another are present as dimmers provided at present on the market, the time-voltage conversion circuit shown in FIG. 9 can only generate a direct current voltage determined uniquely in response to the pulse width since a time constant of the CR filter is fixed. Therefore, in a lighting system using the time-voltage conversion circuit as shown in FIG. 9, there is a problem that only dimming control corresponding to such a variable range of the adjusting knob can be performed. Moreover, there is a problem that a response to a phase change of the input signal is slow since the CR filter is used.

### SUMMARY OF THE INVENTION

This invention has been made paying attention to the problems as described above. It is an object of this invention, in the lighting power supply device that composes the lighting system including the phase-controlled dimmer, to enable setting of control operations corresponding to a type of the dimmer for use and dimming control characteristics desired to be realized, and in addition, to enhance the response to the phase change of the input signal.

According to an aspect of the presently disclosed subject matter, there is provided a lighting power supply device that receives a pulsating flow converted from an alternating current by a rectifying circuit that rectifies the alternating current subjected to phase control by a phase-controlled dimmer, and generates and outputs direct current voltage/current to be supplied to a lamp. The lighting power supply device includes: a transistor that flows the current for turning on the lamp; and a control circuit that receives a voltage corresponding to the current for the lamp as an input and controls the transistor. The control circuit includes: a time-voltage conversion circuit that converts a time decided by a phase of the pulsating flow into a voltage, and a terminal to which a capacitor having an arbitrary capacitance value is connectable; the time-voltage conversion circuit including, a current source capable of charging or discharging the capacitor with a predetermined current; a switching unit capable of switching the charging and the discharging of the capacitor; a sample-and-hold circuit capable of taking in and holding a charging voltage of the capacitor; and a voltage comparison circuit that compares a voltage corresponding to the pulsating flow and a predetermined reference voltage with each other. The time-voltage conversion circuit is configured to make the capacitor to generate a charging voltage corresponding to the phase of the pulsating flow. The sample-and-hold circuit is configured to take in the charging voltage at predetermined timing corresponding to a change of an output of the voltage comparison circuit, and to hold and output the taken-in voltage until next timing.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing schematic configurations of a phase-controlled LED lighting power supply device effective by being applied with the present invention, and of an LED lighting system using the same;

FIG. 2 is a block diagram showing a configuration example of a controlling IC of the LED lighting power supply device that composes a lighting system of an embodiment of the present invention;

FIG. 3 is a circuit configuration diagram showing an embodiment of a time-voltage conversion circuit in the controlling IC;

FIGS. 4A to 4F are timing charts showing states of changes of a signal inputted to the time-voltage conversion circuit in the controlling IC, timing signals generated in in inside thereof, and an output voltage of a sample-and-hold circuit;

FIG. 5 is a time-voltage characteristic chart showing a relationship between a time (a phase of an input signal) in the time-voltage conversion circuit of the embodiment and an output voltage of the sample-and-hold circuit thereof;

FIG. 6 is a diagram showing another configuration example of the controlling IC using the time-voltage conversion circuit;

FIG. 7 is a diagram showing still another configuration example of the controlling IC using the time-voltage conversion circuit and a configuration example of an LED lighting system using the same;

FIGS. 8A and 8B are timing charts showing states of changes of an input signal subjected to phase control and a time-voltage conversion signal generated from the input signal in an LED lighting power supply device using a phase-controlled dimmer; and

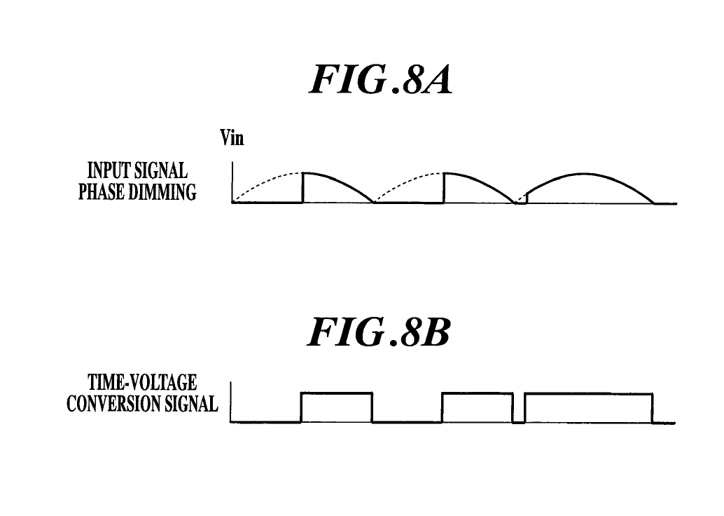

FIG. 9 is a circuit configuration diagram showing a specific example of a general time-voltage conversion circuit examined prior to the present invention.

### DESCRIPTION OF THE PREFERRED EMBODIMENTS

A description is made below of preferred embodiments of the present invention based on the drawings.

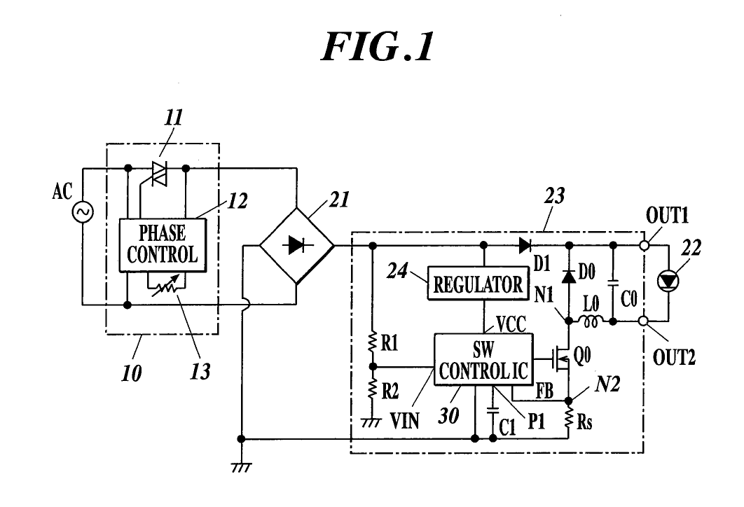

FIG. 1 shows schematic configurations of a phase-controlled LED lighting power supply device effective by being applied with the present invention, and of an LED lighting system using the same.

As shown in FIG. 1, such a phase-controlled LED lighting system of this embodiment is composed of: a phase-controlled dimmer 10 that receives an alternating current power supply voltage AC from a commercial alternating current power supply, controls an ON-phase angle of a switching element, thereby changes a duty ratio of the alternating current power supply voltage, and outputs the alternating current power supply voltage concerned; a rectifying circuit 21 formed of a diode bridge that performs full-wave rectification for such an alternating current inputted thereto and converts the alternating current into a direct current, and the like; an LED lighting power supply circuit 23 formed of an AC-DC converter (a direct current voltage conversion circuit) that supplies desired electric power to an LED lamp 22 as a load based on the direct current voltage/current converted by the rectifying circuit 21; a regulator 24 that generates a power supply voltage necessary for operations of a control circuit 30 of the LED lighting power supply circuit 23; and the like.

The phase-controlled dimmer 10 includes: a switching element 11 such as a thyristor (a diac) and a triac; a control unit 12 that switches on/off the switching element 11 concerned by phase control; and dimming adjusting means 13 formed of a variable resistor and the like. The control unit 12 controls the ON-phase angle of the switching element 11 in response to a state of a resistance value and the like of the dimming adjusting means 13, whereby the phase-controlled dimmer 10 changes the duty ratio of the alternating current power supply voltage, and outputs the alternating current power supply voltage concerned. Note that, in the LED lighting system of FIG. 1, a capacitor C0 connected between output terminals OUT1 and OUT2 between which the LED lamp 22 is connected is a smoothing capacitor that smoothes an output voltage.

The LED lighting power supply circuit 23 of this embodiment includes: an inductor L0, a switching transistor Q0 and a current detecting sense resistor Rs, which are connected in series between the output terminal OUT2 to which the LED lamp 22 is connected and a ground point; a rectifying diode D0 connected between the output terminal OUT1 and a connection node N1 between the inductor L0 and the switching transistor Q0; and a switching controlling semiconductor integrated circuit (a controlling IC) 30 that controls ON/OFF of the switching transistor Q0. The LED lighting power supply circuit 23 is composed of a so-called switching regulator.

Moreover, a potential of a connection node N2, which is subjected to current-voltage conversion by the sense resistor Rs, is inputted as a feedback voltage FB to a controlling IC 30. The controlling IC 30 is configured so as to output a signal for controlling the ON/OFF of the switching transistor Q0 in response to the feedback voltage FB, and to make control so as to stabilize a current flowing through the sense resistor Rs.

Moreover, the LED lighting power supply circuit 23 includes serial resistors R1 and R2 which divide a voltage of a pulsating flow already rectified by the rectifying circuit 21, and the voltage divided by the resistors R1 and R2 is inputted as a monitoring voltage Vin to an input terminal VIN of the controlling IC 30. On the controlling IC 30, an external terminal P1 for connecting an external capacitor C1 thereto is provided. Functions of this capacitor C1 will be described later in detail.

When the potential of the connection node N2 between the transistor Q0 and the sense resistor Rs drops, the controlling IC 30 outputs a control signal for switching on the transistor Q0 to a gate terminal of the transistor Q0. In such a way, the current flows through the transistor Q0 to the ground point; however, since the rectifying diode D0 is reversely connected, the current flowing from the rectifying circuit 21 into the LED lighting power supply circuit 23 flows to the ground point via the LED lamp 22, the inductor L0, the transistor Q0 and the resistor Rs. Then, the LED lamp 22 is turned on by this current, and energy is accumulated in the inductor L0 during this while.

When the current flows through the sense resistor Rs, the potential of the connection node N2 rises, and the controlling IC 30 outputs, to the gate terminal of the transistor Q0, a control signal for switching off the transistor Q0 when a reference voltage in an inside of the controlling IC 30 becomes higher than the potential of the node N2 as a result of comparison therebetween. Then, when the transistor Q0 is switched off, the energy accumulated in the inductor L0 is released, a current going from the inductor L0 through the diode D0 toward the output terminal OUT1 is flown, and the LED lamp 22 is turned on by this current. Such operations as described above are repeated, whereby the LED lamp 22 is turned on continuously. Moreover, the phase of the alternating current input is controlled by the dimmer 10, whereby brightness of the LED lamp 22 is adjusted. A switching frequency of the transistor Q0 by the controlling IC 30 is set so as to become a higher frequency than a frequency of such an alternating current input voltage AC.

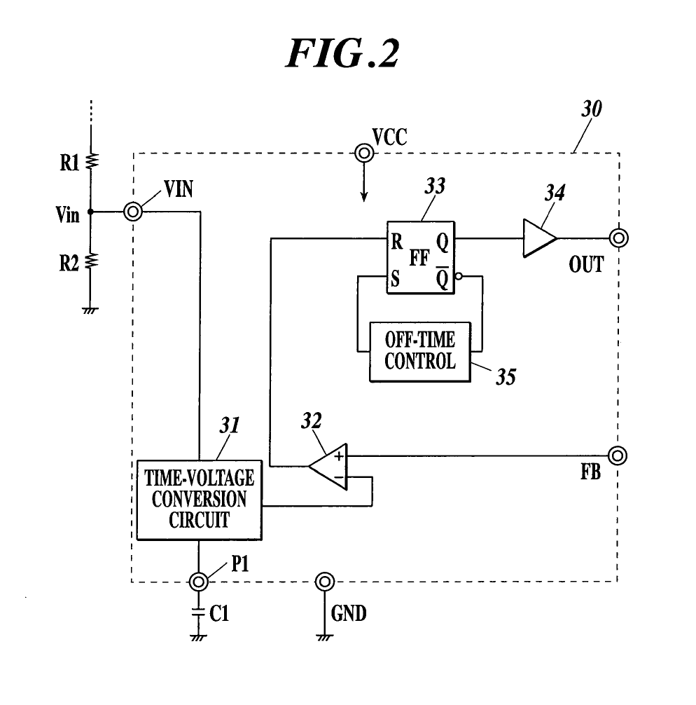

FIG. 2 shows an embodiment of the controlling IC 30 that composes the above-described LED lighting power supply circuit 23.

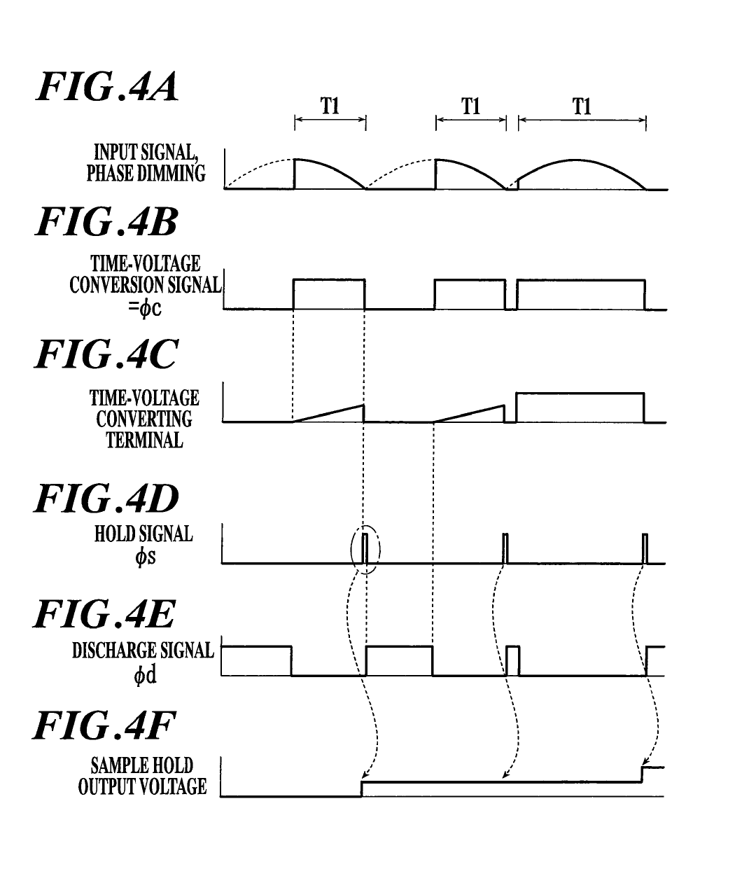

As shown in FIG. 2, the controlling IC 30 of this embodiment includes: a time-voltage conversion circuit 31 that is connected to the input terminal VIN to which the voltage Vin divided by the resistors R1 and R2 is applied and generates a voltage corresponding to a length of a time of an effective portion (T1 of FIG. 4A) of the pulsating flow subjected to the phase control; a voltage comparison circuit (a comparator) 32 that compares an output voltage of the time-voltage conversion circuit 31 and the above-described feedback voltage FB with each other and generates a signal for giving timing to switch off the transistor Q0.

Moreover, the controlling IC 30 includes: a flip-flop 33 that is reset by an output signal of the comparator 32; a driver 34 that outputs an ON/OFF drive signal of the transistor Q0 in response to an output Q of the flip-flop 33; an OFF-time control circuit 35 that is formed of a timer or a delay circuit, generates a signal for switching off the above-described transistor Q0 for a predetermined (fixed) time based on an inverted output /Q of the flip-flop 33 and supplies the signal concerned to a SET signal of the flip-flop 33; and the like.

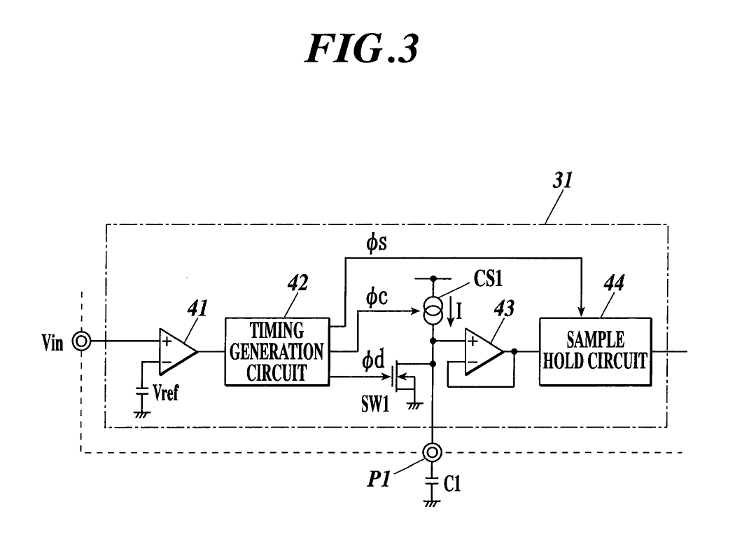

Next, by using FIG. 3, a description is made of a specific embodiment of the time-voltage conversion circuit 31 as a main point of the present invention.

As shown in FIG. 3, the time-voltage conversion circuit 31 in this embodiment includes: a voltage comparison circuit (a comparator) 41 that compares such a voltage Vin inputted to the input terminal VIN and a predetermined reference voltage Vref with each other; and a timing generation circuit 42 that generates predetermined timing signals Øs, Øc and Ød based on an output signal of the comparator 41.

The timing generation circuit 42 may output the output signal of the comparator 41 directly as the timing signal Øc. Moreover, the timing signal Ød can be configured by an inverter that receives the output signal of the comparator 41 or the signal Øc. The timing signal Øs can be generated by a one-shot pulse generation circuit that receives the output signal of the comparator 41 or the signal Øc and generates a one-shot pulse synchronized with a falling edge of the signal.

Moreover, the time-voltage conversion circuit 31 includes: a constant current source CS1 that is switched on/off by the timing signal Øc generated by the timing generation circuit 42 and serves for charging up the capacitor C1 connected to the external terminal P1; a switch transistor SW1 for discharging the capacitor C1; a buffer (voltage follower) 43 for performing impedance conversion for a potential of the external terminal P1 and transmitting the potential; and a sample-and-hold circuit 44 that samples an output voltage of the buffer 43 concerned. The above-described switch transistor SW1 is switched on/off by the timing signal Ød, and the sample-and-hold circuit 44 performs sampling by the timing signal Øs.

Next, a description is made of functions and operations of the above-described time-voltage conversion circuit 31 while referring to FIGS. 4A to 4F.

To the input terminal VIN of the time-voltage conversion circuit 31, the voltage Vin (the pulsating flow) that is as shown in FIG. 4A and subjected to the phase control is inputted. The reference voltage Vref is set at a relatively low potential, and the comparator 41 compares the input voltage Vin and the reference voltage Vref with each other, and thereby outputs a waveform signal (a time-voltage conversion signal) that is as shown in FIG. 4B and rises to a high level only for a time approximate to the effective period T1 of the input voltage Vin.

The timing signal Øc generated by the timing generation circuit 42 has substantially the same waveform as that of the time-voltage conversion signal shown in FIG. 4B, and while the timing signal Øc is being at the high level, the constant current source CS1 flows the current, and the capacitor C1 is charged with this current. Therefore, the potential of the external terminal P1 is changed so as to rise at a substantially constant rate.

As shown in FIG. 4D, the timing signal Øs generated by the timing generation circuit 42 is the one-shot pulse synchronized with the fall of the time-voltage conversion signal Øc shown in FIG. 4B, and by the pulse Øs, the sample-and-hold circuit 44 samples and holds the output voltage of the buffer 43, which is at the same potential as the potential (the charged voltage of the capacitor C1) of the external terminal P1. FIG. 4F shows the output voltage held by the sample-and-hold circuit 44.

As shown in FIG. 4E, the above-described timing signal Ød is a signal with a substantially opposite phase to that of the time-voltage conversion signal shown in FIG. 4B. At timing when the sampling by the sample-and-hold circuit 44 is ended, the switch transistor SW1 is switched on by the timing signal Ød, and discharges electric charges of the capacitor C1, whereby the potential of the external terminal P1 falls down rapidly to the ground potential.

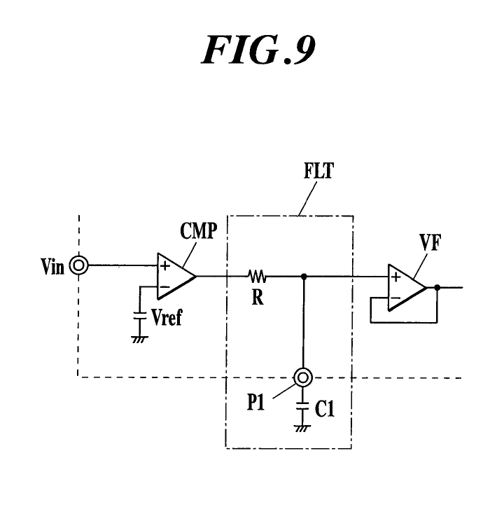

In the time-voltage conversion circuit 31 of this embodiment, unlike the circuit shown in FIG. 9, the RC filter is not provided, but the sample-and-hold circuit 44 is provided instead, and accordingly, there is an advantage that, when the phase of the input voltage Vin is changed, the output voltage can be allowed to respond thereto rapidly.

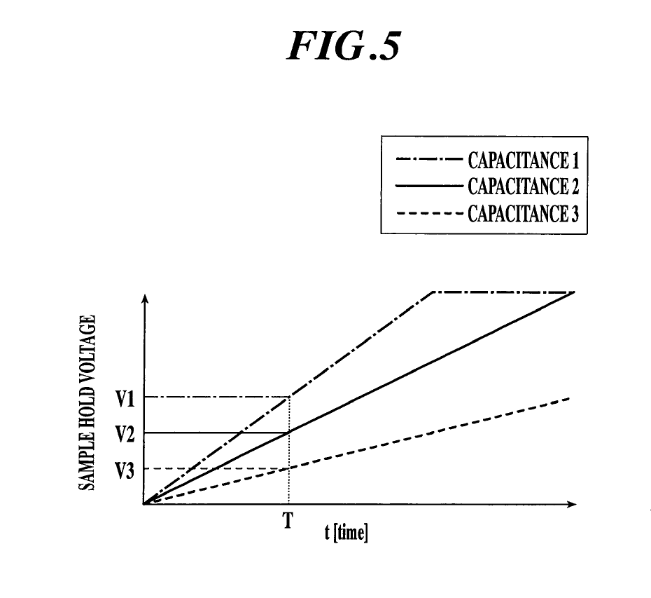

Moreover, in the time-voltage conversion circuit 31 of this embodiment, as shown in FIG. 5, when a capacitance value of the capacitor C1 is changed, time characteristics of the output voltage of the sample-and-hold circuit 44 can be changed. That is to say, if such a capacitor C1 with a large capacitance value is connected to the external terminal P1 in advance, then a charging voltage of the capacitor C1, which reaches after a predetermined time, can be lowered, and if such a capacitor C1 with a small capacitance value is connected to the external terminal P1 in advance, then the charging voltage of the capacitor C1, which reaches after the predetermined time can be raised.

Plural dimmers in which variable ranges (variable angles and variable distances) of adjusting knobs differ from one another are present as dimmers provided at present on the market, and a policy (a design concept) as to how to set the brightness with respect to a variation of the knob also differs among manufacturers. However, by changing the capacitance value of the capacitor C1, the time-voltage conversion circuit 31 of this embodiment can generate and output different voltages with respect to the same-phase signal of the input voltage Vin.

As a result, in the LED lighting system of FIG. 1, which uses the controlling IC building therein the time-voltage conversion circuit 31 as in the embodiment, there is an advantage that it becomes possible to perform dimming control with a high degree of freedom with respect to the variation of the adjusting knob of the dimmer 10. That is to say, by changing the capacitance value of the capacitor C1, a dimming control curve (a sensitivity of the knob) with respect to an adjustment amount in the dimmer can be freely set.

Moreover, in the time-voltage conversion circuit 31 of this embodiment, the node that gives the potential serving as a sampling target of the sample-and-hold circuit 44 is connected to the external terminal P1, and accordingly, in place of connecting the capacitor C1 to the external terminal P1 in advance as in FIG. 3, a control voltage is inputted to the terminal P1 from the outside, whereby the dimming can be controlled. Therefore, the system that performs the dimming by the voltage control mode can be easily realized without increasing the number of pins and the number of elements in the IC, that is, without bringing about a cost increase. Furthermore, there is also an advantage that the IC can be inspected by using this terminal.

The description has been made of the case where the dimmer 10 is of the type of controlling the leading edge (the rise) of the phase of the alternating current waveform; however, even in the case where the dimmer 10 is of a type of controlling a trailing edge (a fall) of the phase of the alternating current waveform, the voltage corresponding to the input signal subjected to the phase control can be rapidly outputted in accordance with a principle similar to that mentioned above.

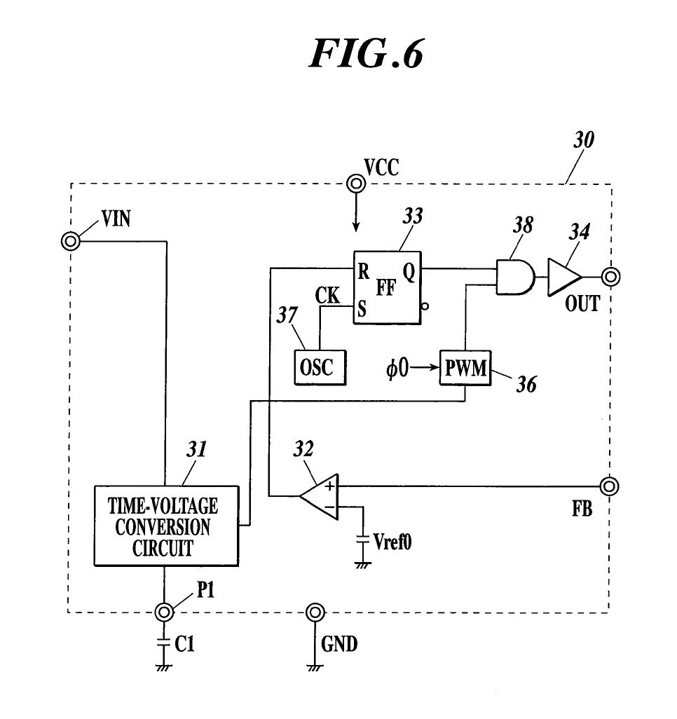

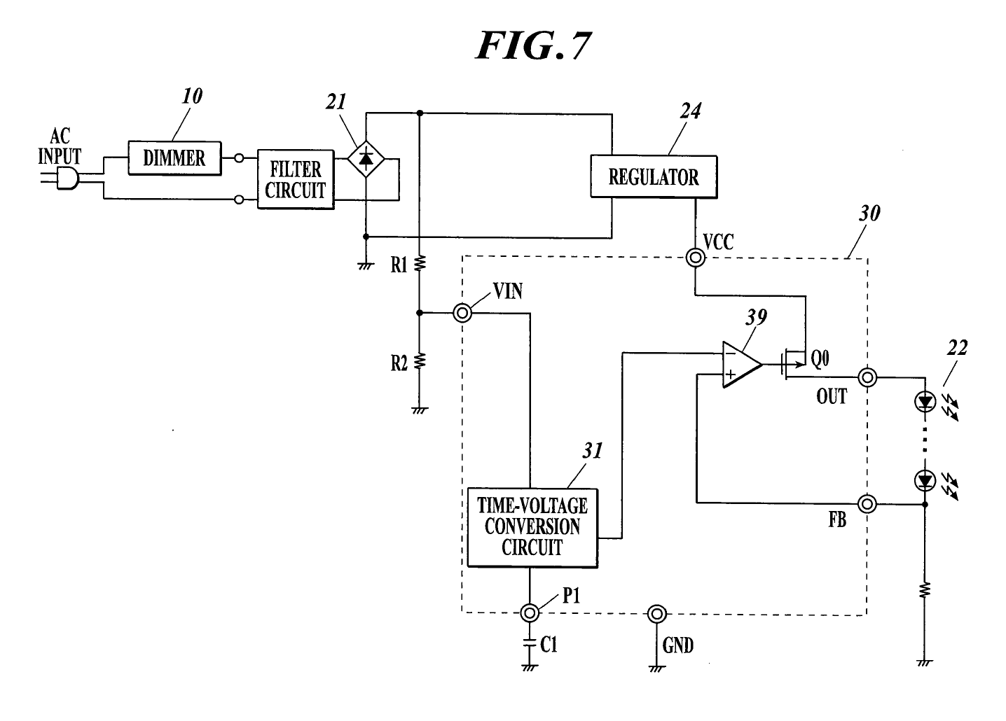

FIG. 6 and FIG. 7 show another configuration example of the controlling IC using the time-voltage conversion circuit of the above-described embodiment and a configuration of an LED lighting system using the same.

Among them, in FIG. 6, for a controlling IC 30 that controls the transistor Q0 flowing the current through the LED lamp 22 by a pulse width modulation (PW) mode, the time-voltage conversion circuit 31 of the above-described embodiment is used. In this embodiment, the controlling IC 30 includes: a PWM pulse generation circuit 36 that applies not the output voltage of the time-voltage conversion circuit 31 but a predetermined reference voltage Vref0 to an inverted input terminal side of the comparator 32 to which the feedback voltage FB is to be inputted; and generates a PWM control pulse, which has a pulse width corresponding to the phase of the input voltage Vin, from the output voltage of the time-voltage conversion circuit 31 and a predetermined frequency signal Ø0; and an oscillation circuit 37 that generates a predetermined frequency clock signal CK.

Then, the controlling IC 30 is configured so as to input the output signal of the above-described comparator 32 to a RESET signal of the flip-flop 33, and to input the clock signal CK, which is outputted from the oscillation circuit 37, to the SET terminal of the flip-flop 33. Moreover, between a flip-flop 33 and a driver 34, an AND gate 38 is provided, which takes a logical product between the PWM control pulse outputted from the PWM pulse generation circuit 36 and an output signal of the flip-flop 33. Also in the controlling IC of this embodiment, the time-voltage conversion circuit 31 is configured so as to include a configuration as shown in FIG. 3, whereby similar effects to those described in the above-mentioned embodiment can be exerted in the LED lighting system using the controlling IC 30 concerned.

FIG. 7 shows a configuration example where the time-voltage conversion circuit 31 of the above-described embodiment is used for the controlling IC 30 that controls the transistor Q0, which flows the current through the LED lamp 22, by a series regulator mode. In this embodiment, the controlling IC 30 is configured so as to provide an error amplifier (an error amplifying circuit) 39 that outputs a voltage corresponding to a potential difference between the feedback voltage FB and the output voltage of the time-voltage conversion circuit 31, and to control the current by applying an output voltage of the error amplifier 39 concerned to the gate terminal of the transistor Q0.

Also in the controlling IC 30 of this embodiment, the time-voltage conversion circuit 31 is configured so as to include the configuration as shown in FIG. 3, whereby similar effects to those described in the above-mentioned embodiment can be exerted in the LED lighting system using the controlling IC 30 concerned.

The description has been specifically made above of the present invention, which is made by the inventor thereof, based on the embodiments; however, the present invention is not limited to the above-described embodiments. For example, in the time-voltage conversion circuit (FIG. 3) of each of the above-described embodiment, it is described that the constant current source CS1 is switched on/off by the timing signal Øc; however, such a configuration may be adopted, in which, instead of directly switching on/off the constant current source CS1, an ON/OFF switch or a switching switch is provided between the constant current source CS1 and the external terminal P1, and the current from the constant current source CS1 is switched on/off or switched by the timing signal Øc, whereby the capacitor C1 is charged only for a high-level period of the timing signal Øc.

Moreover, as the time-voltage conversion circuit of each of the above-described embodiments, the one of the type is illustrated, in which the external capacitor C1 is charged by the constant current source CS1 and is discharged by the switch transistor SW1; however, it is also possible to configure the time-voltage conversion circuit as a circuit of a type in which the capacitor is discharged by the constant current source after being charged by the switch transistor.

Moreover, in each of the above-described embodiments, as the LED lighting power supply circuit 23, the one is illustrated, which includes the switching transistor Q0, the diode D0 and the inductor L0; however, it is also possible to configure the AC-DC converter 31 as a switching regulator of a so-called synchronized rectification type, which uses a transistor instead of the diode D0, and makes the ON/OFF control for this transistor by the controlling IC 30 complementarily with the switching transistor Q0.

The description has been made above of the one in which the present invention is applied to the LED lighting system as an application field that has served as a background thereof; however, the present invention is not limited to this, and can also be used for a lighting system that uses a lighting fixture other than the LED lamp and performs the dimming by the phase control mode.

In accordance with one or more embodiments as described above, the voltage value to be generated in response to the phase of the pulsating flow as the input signal can be changed by changing the capacitance value of the capacitor that composes the time-voltage conversion circuit, whereby the setting of the control operations corresponding to the type of the dimmer for use and to the dimming control desired to be realized. Moreover, since the time can be converted into the voltage without using the CR filter, the response to the phase change of the input signal can be enhanced.

Preferably, the control circuit is configured as a semiconductor integrated circuit, the terminal is provided as an external terminal of the semiconductor integrated circuit, and the capacitor is configured as an external element to be connected to the external terminal.

In such a way, it becomes possible to easily change the capacitance value of the capacitor that composes the time-voltage conversion circuit. Moreover, the control voltage is inputted from the outside to the external terminal to which the capacitor is to be connected, whereby the dimming can also be controlled.

Preferably, the time-voltage conversion circuit further includes a timing generation circuit to generate a timing signal for allowing the switching unit to perform ON/OFF operations based on the output of the voltage comparison circuit and to generate a timing signal for operating the sample-and-hold circuit.

In such a way, it is not necessary to input, from the outside, the timing signal for operating the switching unit and the sample-and-hold circuit, and a load on a system designer can be reduced.

Preferably, the time-voltage conversion circuit further includes, between the external terminal and the sample-and-hold circuit, a voltage buffer that performs impedance conversion for the charging voltage of the capacitor and transmits the charging voltage to the sample-and-hold circuit.

In such a way, the charging voltage of the capacitor can be avoided being changed by operating the sample-and-hold circuit.

As described above, in accordance with the presently disclosed subject matter, in the lighting power supply device that composes the LED lighting system including the phase-controlled dimmer, the setting of the control operations corresponding to the type of the dimmer for use and the dimming control characteristics desired to be realized can be performed. Moreover, there is an effect that the response to the phase change of the input signal can be enhanced.

The entire disclosure of Japanese Patent Application No. 2011-077397 filed on Mar. 31, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A lighting power supply device that receives a pulsating flow converted from an alternating current by a rectifying circuit that rectifies the alternating current subjected to phase control by a phase-controlled dimmer, and generates and outputs direct current voltage/current to be supplied to a lamp, the lighting power supply device comprising:
a transistor that flows the current for turning on the lamp; and
a control circuit that receives a voltage corresponding to the current for the lamp as an input and controls the transistor, the control circuit including,
a time-voltage conversion circuit that converts a time decided by a phase of the pulsating flow into a voltage, and
a terminal to which a capacitor having an arbitrary capacitance value is connectable;
the time-voltage conversion circuit including,
a current source capable of charging or discharging the capacitor with a predetermined current;
a switching unit capable of switching the charging and the discharging of the capacitor;
a sample-and-hold circuit capable of taking in and holding a charging voltage of the capacitor; and
a voltage comparison circuit that compares a voltage corresponding to the pulsating flow and a predetermined reference voltage with each other,
wherein the time-voltage conversion circuit is configured to make the capacitor to generate a charging voltage corresponding to the phase of the pulsating flow, and
wherein the sample-and-hold circuit is configured to take in the charging voltage at predetermined timing corresponding to a change of an output of the voltage comparison circuit, and to hold and output the taken-in voltage until next timing.

2. The lighting power supply device according to claim 1,
wherein the control circuit is configured as a semiconductor integrated circuit,
the terminal is provided as an external terminal of the semiconductor integrated circuit, and
the capacitor is configured as an external element to be connected to the external terminal.

3. The lighting power supply device according to claim 2, wherein the time-voltage conversion circuit further comprises a timing generation circuit to generate a timing signal for allowing the switching unit to perform ON/OFF operations based on the output of the voltage comparison circuit and to generate a timing signal for operating the sample-and-hold circuit.

4. The lighting power supply device according to claim 3, wherein the time-voltage conversion circuit further comprises, between the external terminal and the sample-and-hold circuit, a voltage buffer that performs impedance conversion for the charging voltage of the capacitor and transmits the charging voltage to the sample-and-hold circuit.
